(19) United States
(12) Patent Application Publication
(10) Pub. No.: US 2016/0037893 A1
(43) Pub. Date: Feb. 11, 2016

(54) DEODORANT SAVER

(71) Applicant: Gary Walker, Antioch, CA (US)

(72) Inventor: Gary Walker, Antioch, CA (US)

(21) Appl. No.: 14/815,922

(22) Filed: Jul. 31, 2015

Related U.S. Application Data
(60) Provisional application No. 62/031,789, filed on Jul. 31, 2014.

(51) Int. Cl. A45D 40/16; B29C 33/44; A45D 40/04; B29C 33/02

(52) U.S. Cl. CPC A45D 40/16; B29C 33/02; B29C 33/442; A45D 40/04

(57) ABSTRACT

A device to reclaim slivers of deodorant comprising a heated molding device configured to receive and melt or compress multiple slivers of deodorant into one standard sized bar, comprising a plastic cylindrical container capable of containing solid deodorant having an oval cross-section, and an internal lifting platform operated with a twist knob at its bottom to raise the solid deodorant as it is used, the improvement comprising a base having a heating element, the cylindrical container fits into the base to heat the slivers thus allowing the slivers to melt.

### CLAIM OF PRIORITY

This patent application claims priority under 35 USC 119 (e) (1) from U.S. Provisional Patent Application Ser. No. 62/031,789 filed Jul. 31, 2014, of common inventorship herewith entitled, “Deodorant Saver,” which is incorporated herein by reference as though the same were set forth in its entirety.

### FIELD OF THE INVENTION

The present invention pertains to the field of hygiene accessories, and more specifically to the field of soap and deodorant holders.

### BACKGROUND OF THE INVENTION

The prior art has put forth several designs for soap and deodorant holders. Among these are:

U.S. Pat. No. 4,917,589 to David A. Manderson describes a soap bar forming apparatus that includes a generally hollow housing having an aperture extending there through and a removable base. After soaking a plurality of soap particles or chips, each of which is the residue of a substantially used soap bar, in water to allow the soap particles to become soft and pliable, the soap particles are placed in the housing with its base attached thereto. A plunger or compressing element is inserted into the housing's aperture and manually displaced therein so as to compress the soap particles which adhere to one another in forming a composite bar of soap with a shape defined by the housing, its base, and the plunger. The base is removed from the housing to permit the composite soap bar to be removed from the housing by continued displacement of the plunger. The base and housing are coupled by threaded engagement, a flange and slot arrangement or by virtually any conventional means. Similarly, the interior of the housing as well as the facing portions of the base and the plunger are configured to provide a wide variety of soap bar shapes and sizes.

U.S. Pat. No. 4,035,122 to John Daniel Cavanaugh describes a lightweight portable device that is utilized to save soap by subjecting the remnants of bars of soap to compression to reform the remnants into a solid bar of desired configuration. Surplus water associated with the remnants is discharged from the device during the reforming operation. After the remnants have been reformed into a solid bar, the bar is ejected from the device by a simple manual operation. The device is particularly adapted to being formed in its entirety from a polymerized resin such as polyethylene, polypropyline or the like by conventional molding techniques.

U.S. Pat. No. 4,030,867 to Don D. Everman describes an apparatus for forming a bar of soap from leftover pieces that includes a hopper for holding pieces until enough are collected to form a new bar. Then a weight sensor causes the activation of a heater which melts the collected soap. The molten soap runs into a mold, thus producing a new bar.

None of these prior art references describe the present invention.

### SUMMARY OF THE INVENTION

It is an object of the present invention to provide a heated molding device configured to compress multiple slivers of deodorant into one standard sized bar.

### BRIEF DESCRIPTION OF THE DRAWINGS

FIG. 1 illustrates prototypical diagonal and front views of two components of the present invention, a device that melts and molds deodorant slivers into a solid bar and a dispenser in which the newly molded solid bar is inserted.

FIG. 2 illustrates four dispensers, each dispenser portraying different colors and decorative patterns.

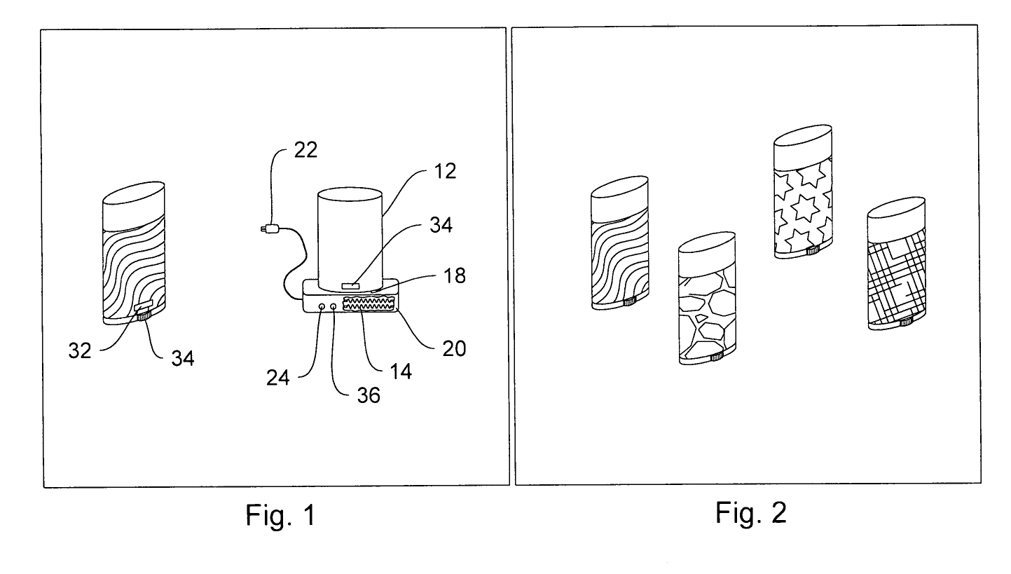

### DETAILED DESCRIPTION OF THE INVENTION

Learning the value of saving money is of key importance to anyone who wishes to lead a successful and comfortable life. Whether a small child carefully saving pennies and nickels in a brightly colored piggy bank, a teenager socking away a weekly allowance to buy a new outfit or an adult putting aside loose change in a coffee can, regularly saving even a small amount of money is a prudent way in which people earn cash necessary for those little extras in life. An extremely popular way in which people save money is by undergoing simple steps to prevent unnecessary waste. Making sure to turn off lights when leaving a room to save a few dollars on an electric bill, scraping the last few dollops of peanut butter out of the jar before tossing it in the trash to prevent food waste, or dampening a mascara wand with a few drops of water in order to extend the life of an expensive cosmetic. Taking steps to prevent waste results in extra money to pay for an unexpected auto repair or take an enjoyable night out with friends.

Perhaps one of the most commonly wasted products in any household is deodorant. Quickly deteriorating, a large, expensive bar of deodorant can end up a small worthless sliver in a manner of a few days. Extremely soft and small, these slivers of deodorant are difficult to handle and impractical to use. Once a bar of deodorant dissolves into small pieces, it becomes easily trapped in drainage systems and plumbing, resulting in costly repair bills. Most individuals simply toss their slivers of deodorant in the garbage, rather than deal with the hassle of attempting to fully utilize them.

Please refer to the Figures.

The present invention, hereinafter referred to as the Deodorant Saver, is a heated molding device 10 configured to compress multiple slivers of deodorant into one standard sized bar. The Deodorant Saver prevents unnecessary waste of deodorant which often occurs when the deodorant becomes too small to efficiently serve its purpose. The Deodorant Saver is a small or medium sized container or receptacle 12, inside which a user can drop individual pieces of deodorant. The Deodorant Saver container 12 is constructed in a form similar to the original solid deodorant packaging, i.e., a plastic cylindrical container capable of containing solid deodorant having an oval cross-section, and an internal lifting platform 32 operated with a twist knob 34 at its bottom to raise the solid as it is used, further comprising a base 20 having a heating element 14, further wherein the cylindrical container 12 fits into the base 20 to heat the slivers thus allowing the slivers to melt.

In an embodiment, the device operates on standard 110v household power by use of external cord 22. In an embodiment, the device is operated by to AA batteries. An On and Off switch 24 is included for use in activating the present invention. An indicator light 36 is illuminated when the heating element is turned on. The Deodorant Saver is available in a wide variety of colors and styles.

Using the Deodorant Saver is simple and straightforward. The present invention is usable with any brand, scent or style of solid deodorant. A user utilizes a favorite deodorant as normal. As the deodorant deteriorates in size and texture, the user tosses the remaining sliver of deodorant into the Deodorant Saver molding container. Gradually collecting several slivers of deodorant, the user adds these slivers to the container until the Deodorant Saver is completely filled. The user powers on the Deodorant Saver and the internally contained heating elements soften the deodorant slivers allowing them to melt. When the slivers have been completely melted, the heating element is turned off and the deodorant is permitted to cool into the shape of a new bar of deodorant. In an alternative embodiment, an the integrated compression component presses the slivers to bind these slivers together. The user opens the present invention to expose a freshly molded bar of deodorant. The user utilizes this newly molded deodorant in the same manner as any other solid deodorant.

Molding several small pieces of deodorant into one large solid, the Deodorant Saver effectively prevents these slivers from clogging a shower, bath or sink drain. Organized in individual containers, the Deodorant Saver permits each member of the household to possess his or her own deodorant in a selected unique color or pattern. Durably constructed from heavy duty plastic and rubber materials, the Deodorant Saver will withstand years of repeated use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device to reclaim slivers of deodorant comprising a heated molding device configured to receive and melt or compress multiple slivers of deodorant into one standard sized bar, comprising a plastic cylindrical container capable of containing solid deodorant having an oval cross-section, and an internal lifting platform operated with a twist knob at its bottom to raise the solid deodorant as it is used, further comprising a base having a heating element, further wherein the cylindrical container fits into the base to heat the slivers thus allowing the slivers to melt.

2. The device of claim 1, wherein the device further comprises an electric cord and operates on standard 110v household power by use of the electric cord.

3. The device of claim 1, further comprising a battery compartment capable of holding two AA batteries and the device operates on two AA batteries.

4. The device of claim 1 further comprising an On and Off switch.

5. The device of claim 1 further comprising an indicator light, wherein the indicator light is illuminated when the heating device is turned on. The Deodorant Saver is available in a wide variety of colors and styles.

6. The device of claim 2, further comprising an On and Off switch.

7. The device of claim 2 further comprising an indicator light, wherein the indicator light is illuminated when the heating device is turned on. The Deodorant Saver is available in a wide variety of colors and styles.

8. The device of claim 3, further comprising an On and Off switch.

9. The device of claim 3, further comprising an indicator light, wherein the indicator light is illuminated when the heating device is turned on. The Deodorant Saver is available in a wide variety of colors and styles.
